(19) United States
(12) Patent Application Publication
(10) Pub. No.: US 2022/0322873 A1
(43) Pub. Date: Oct. 13, 2022

(54) SANDWICH MAKER

(71) Applicant: MOU-LI LIN, TAINAN CITY (TW)

(72) Inventor: MOU-LI LIN, TAINAN CITY (TW)

(21) Appl. No.: 17/225,241

(22) Filed: Apr. 8, 2021

(51) Int. Cl. A47J 37/06; A23P 20/20; A47J 27/13; A47J 36/32

(52) U.S. Cl. CPC A47J 37/0611; A23P 20/20; A47J 27/13; A47J 36/32

(57) ABSTRACT

A sandwich maker includes a lower baking plate, a baking ring, an upper baking plate, a partition, and a heat insulation ring. The partition can be pulled out through a handle to separate the partition together with the heat insulation ring from the baking ring, so that the interiors of the lower baking plate, the baking ring and the upper baking plate communicate with each other. The sandwich maker can separate the ingredients for cooking and can directly assemble the ingredients to form a sandwich. The removed partition can be easily placed through the heat insulation ring without worrying that the partition may damage a tabletop.

### FIELD OF THE INVENTION

The present invention relates to a sandwich maker, and more particularly to a sandwich maker that can cook different ingredients separately and directly assemble all the ingredients to form a sandwich after cooking.

### BACKGROUND OF THE INVENTION

A sandwich is an item of food consisting of two pieces of toast with meat, jelly, cheese, or other filling between them. Two buns, focaccia, French bread and the like may be used instead of the two pieces of toast.

Because a sandwich is quick and easy to prepare, it is one of the foods chosen for family outings or company meetings. However, when a sandwich is to be prepared, taking a toast sandwich as an example, if the toast sandwich is sandwiched with an egg or meat, the toast will become soft when wet to affect the taste of the sandwich. It is necessary to prepare the toast and the egg/meat separately. After the toast is heated and the egg/meat is cooked, the toast and the egg/meat are assembled manually to form a complete sandwich. If the number of sandwiches to be prepared is large, the preparer may be in a rush and a muddle.

### SUMMARY OF THE INVENTION

The primary object of the present invention is to provide a sandwich maker which can cook different ingredients separately and directly assemble all the ingredients to form a sandwich after being cooked.

The sandwich maker comprises a lower baking plate, a baking ring, an upper baking plate, a partition, and a heat insulation ring. The baking ring is adjacent to the lower baking plate. The baking ring is pivotable relative to the lower baking plate. The upper baking plate is adjacent to the baking ring. The upper baking plate is pivotable relative to the lower baking plate. The partition is selectively coupled to the baking ring. The partition has a partition bottom surface, a partition side surface, a handle, and a partition element. When the partition is coupled to the baking ring, the partition bottom surface is located between the lower baking plate and the upper baking plate, the partition side surface and the handle extend out of the baking ring, and the partition element is arranged at a distance from the partition bottom surface. The heat insulation ring is coupled to the partition side surface. The partition bottom surface, the baking ring and the lower baking plate define a first space. The partition bottom surface, the baking ring and the partition element define a second space. The partition element, the baking ring and the upper baking plate define a third space. When the partition is pulled through the handle to separate the partition together with the heat insulation ring from the baking ring, the first space, the second space and the third space communicate with each other.

Preferably, the baking ring includes a lower baking ring and an upper baking ring that are pivotable relative to the lower baking plate. The lower baking ring is adjacent to the lower baking plate. The upper baking ring is adjacent to the lower baking ring and the upper baking plate. The partition is selectively coupled between the lower baking ring and the upper baking ring. When the partition is coupled between the lower baking ring and the upper baking ring, the partition bottom surface is located between the lower baking ring and the upper baking ring, the handle extends out of the lower baking ring and the upper baking ring, and the partition element extends from the handle into the upper baking ring. The partition bottom surface, the lower baking ring and the lower baking plate define the first space. The partition bottom surface, the upper baking ring and the partition element define the second space. The partition element, the upper baking ring and the upper baking plate define the third space.

Preferably, the sandwich maker further comprises an upper casing and a lower casing that are pivotally connected to each other through a pivot rod. The upper baking plate and the lower baking plate are coupled to opposing surfaces of the upper casing and the lower casing, respectively. The lower baking ring and the upper baking ring are pivotally connected to the pivot rod.

Preferably, the pivot rod includes a first pivot rod and a second pivot rod. The upper casing has a pivot portion. The pivot portion of the upper casing and the lower casing are pivotally connected to each other through the first pivot rod. The pivot portion of the upper casing, the lower baking ring and the upper baking ring are all pivotally connected to the second pivot rod. The pivot portion has a notch. The notch has a width not less than a diameter of the second pivot rod. When the lower baking ring and the upper baking ring are moved toward the notch, the second pivot rod comes out of the pivot portion from the notch for the lower baking ring and the upper baking ring to be separated from the upper baking plate and the lower baking plate.

Preferably, a bottom of the lower casing is provided with a pad.

Preferably, the upper baking ring has a perforation and a first rib. The partition element is a second rib. When the partition is coupled between the lower baking ring and the upper baking ring, the second rib passes through the perforation and extends into the upper baking ring, and the second rib corresponds to the first rib.

Preferably, an outer edge of the upper baking ring is provided with a first coupling portion, and an inner edge of the partition is provided with a second coupling portion. When the partition is coupled between the lower baking ring and the upper baking ring, the first coupling portion is engaged with the second coupling portion.

Preferably, the partition side surface is perpendicular to the partition bottom surface. The partition side surface further has an engaging groove for the heat insulation ring to be engaged with the partition side surface.

Preferably, a grip protrudes from one or a combination of the lower baking plate, the lower baking ring, the upper baking ring and the upper baking plate.

Preferably, an indicator light is electrically connected to the upper baking plate and/or the lower baking plate.

According to the above technical features, the following effects can be achieved.

1. With the partition and its partition element, the spaces inside the upper baking plate, the lower baking plate and the baking ring can be separated into the first space, the second space and the third space during cooking, so as to cook the different ingredients of the sandwich separately. After the cooking is completed, the partition is pulled out for the first space, the second space and the third space to communicate with each other, and all the ingredients are directly assembled to form a sandwich.

2. The partition side surface of the partition is coupled with the heat insulation ring, which is convenient for the user to place the partition with ease after the partition is removed, without worrying that the high-temperature partition may damage the tabletop.

3. The partition can be pulled through the handle, or the lower baking plate, the lower baking ring, the upper baking ring and the upper baking plate can be pivoted and pulled through the grips. This can prevent the user from being burned by the high-temperature sandwich maker.

4. Through the notch of the upper casing, the lower baking ring and the upper baking ring can be removed for cleaning.

5. Through the perforation of the upper baking ring, the partition element can be inserted through the perforation. By the cooperation of the first coupling portion and the second coupling portion, the partition can be driven by the upper baking ring to pivot.

6. Through the indicator light, it is convenient for the user to confirm whether the upper baking plate and/or the lower baking plate are heated normally.

### BRIEF DESCRIPTION OF THE DRAWINGS

FIG. 1 is a perspective view according to a first embodiment of the present invention;

FIG. 2 is a partially exploded view according to the first embodiment of the present invention;

FIG. 3 is an exploded view according to the first embodiment of the present invention;

FIG. 4 is a partially cross-sectional view according to the first embodiment of the present invention;

FIG. 5 is a first schematic view according to the first embodiment of the present invention, illustrating that a first piece of toast is placed into the lower baking ring;

FIG. 6 is a second schematic view according to the first embodiment of the present invention, illustrating that an egg is cooked on the partition and a second piece of toast is to be placed onto the first rib and the second rib;

FIG. 7 is a cross-sectional view according to the first embodiment of the present invention when in use, illustrating that the first piece of toast and the second piece of toast are separated from the egg;

FIG. 8 is a third schematic view according to the first embodiment of the present invention, illustrating that the partition is pulled out;

FIG. 9 is a fourth schematic view according to the first embodiment of the present invention, illustrating that the first piece of toast, the egg and the second piece of toast are assembled to form a sandwich;

FIG. 10 is a fifth schematic view according to the first embodiment of the present invention, illustrating that the upper baking ring and the lower baking ring are removed;

FIG. 11 is an exploded view according to a second embodiment of the present invention;

FIG. 12 is a perspective view according to the second embodiment of the present invention; and

FIG. 13 is a schematic view according to the second embodiment of the present invention, illustrating that a first hamburger bun, an egg and a second hamburger bun are assembled to form a sandwich.

### DESCRIPTION OF THE PREFERRED EMBODIMENTS

Embodiments of the present invention will now be described, by way of example only, with reference to the accompanying drawings.

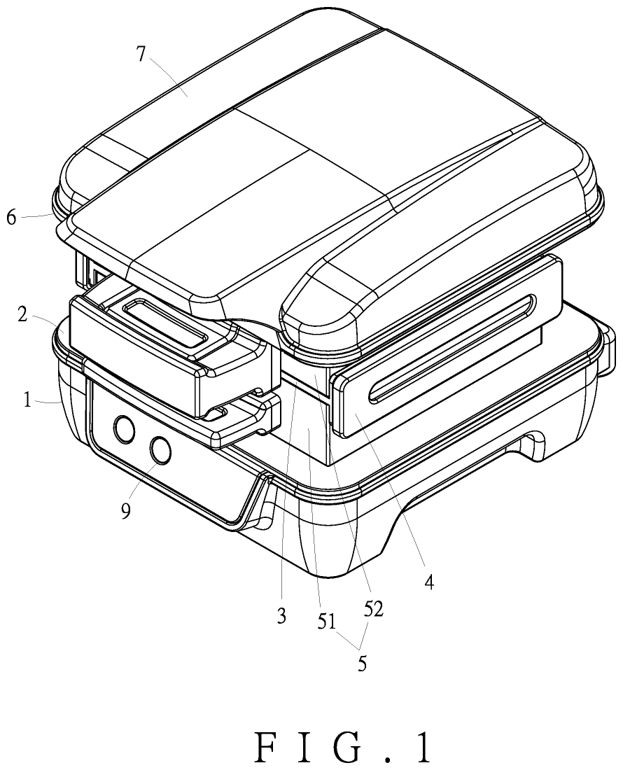

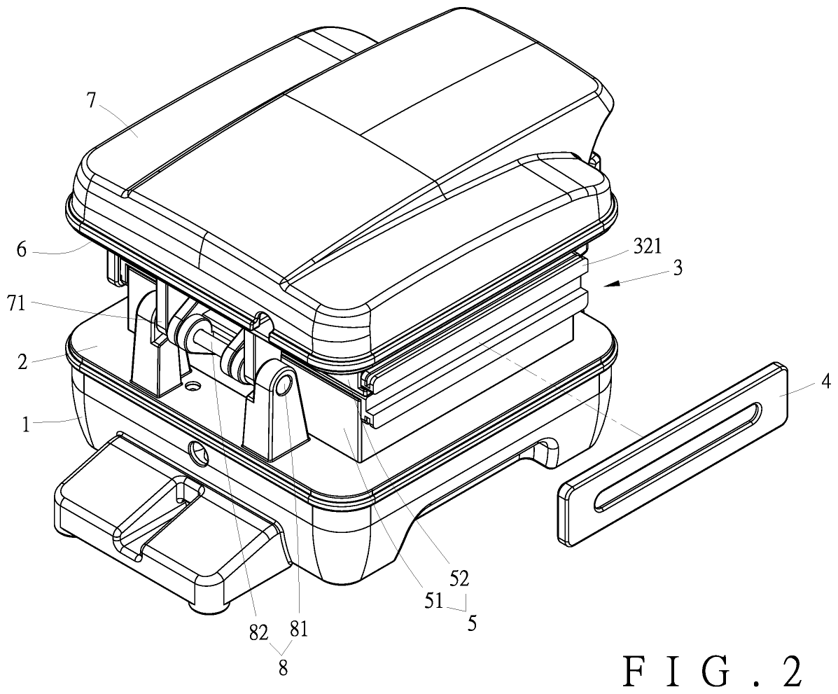

Referring to the FIG. 1 and FIG. 2, a sandwich maker according to a first embodiment of the present invention comprises a lower casing 1, a lower baking plate 2, a partition 3, a heat insulation ring 4, a baking ring 5, an upper baking plate 6, and an upper casing 7. In this embodiment, the lower casing 1 and the upper casing 7 are pivotally connected to each other through a pivot rod 8. An indicator light 9 is electrically connected to the upper baking plate 6 and the lower baking plate 2 for the user to confirm whether the upper baking plate 6 and the lower baking plate 2 work normally.

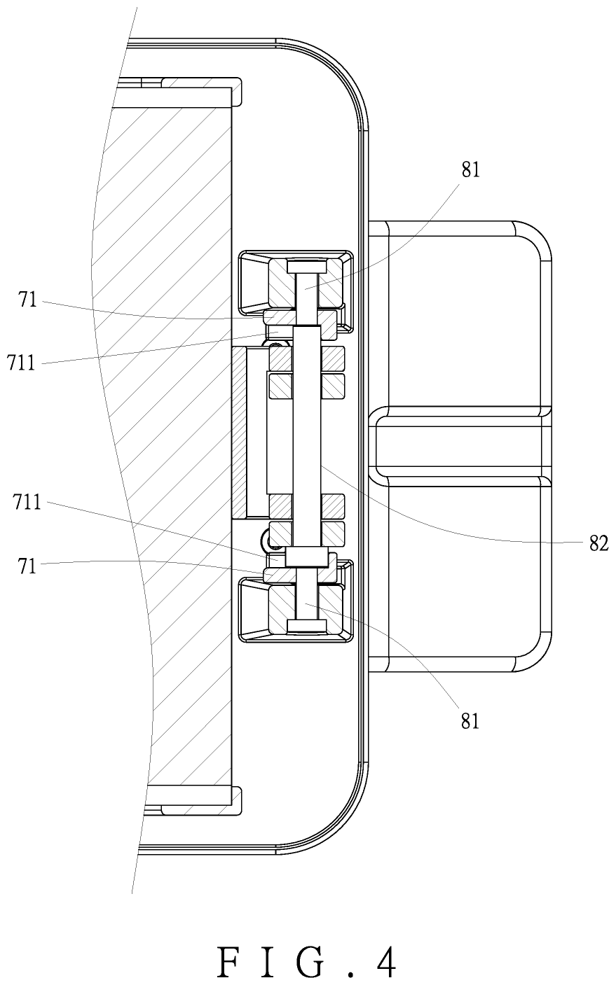

Referring to FIG. 2 through FIG. 4, the lower baking plate 2 and the upper baking plate 6 are coupled to the opposing surfaces of the lower casing 1 and the upper casing 7, respectively. The baking ring 5 is located between the lower baking plate 2 and the upper baking plate 6. The upper baking plate 6 and the lower baking plate 2 are electrically connected to an external socket (not shown) and each include a tubular electric heating element (not shown) to serve as the heat source of the sandwich maker. The sandwich maker may be provided with a switch (not shown) to control the opening and closing of the upper baking plate 6 and the lower baking plate 2.

The lower baking plate 2 and the upper baking plate 6 can be relatively pivoted through the lower casing 1, the upper casing 7 and the pivot rod 8. The baking ring 5 is also pivotally connected to the pivot rod 8. In more detail, the baking ring 5 includes a lower baking ring 51 and an upper baking ring 52. The pivot rod 8 includes a first pivot rod 81 and a second pivot rod 82. The upper casing 7 has a pivot portion 71. The pivot portion 71 has a notch 711. The width of the notch 711 is not less than the diameter of the second pivot rod 82. The pivot portion 71 of the upper casing 7 and the lower casing 1 are pivotally connected to each other through the first pivot rod 81. The pivot portion 71 of the upper casing 7, the lower baking ring 51 and the upper baking ring 52 are all pivotally connected to the second pivot rod 82, so that the lower baking ring 51 is adjacent to the lower baking plate 2, and the upper baking ring 52 is adjacent to the upper baking plate 6. Both the lower baking ring 51 and the upper baking ring 52 are pivotable relative to the lower baking plate 2 and the upper baking plate 6.

The upper baking ring 52 has a perforation 521, a first coupling portion 522, and a first rib 523.

The partition 3 is selectively coupled between the lower baking ring 51 and the upper baking ring 52. The partition 3 has a partition bottom surface 31, a partition side surface 32, a handle 33, and a partition element. The partition element is a second rib 34. The partition 3 further has a second coupling portion 35. When the partition 3 is coupled to the baking ring 5, the partition bottom surface 31 is located between the lower baking ring 51 and the upper baking ring 52, and the second coupling portion 35 on the inner edge of the partition 3 is correspondingly engaged with the first coupling portion 522 on the outer edge of the upper baking ring 52. At this time, both the partition side surface 32 and the handle 33 extend from the partition bottom surface 31 to the outsides of the lower baking ring 51 and the upper baking ring 52. The second rib 34 passes through the perforation 521 from the handle 33 and extends into the upper baking ring 52. The second rib 34 is arranged at a distance from the partition bottom surface 31 and corresponds to the first rib 523. In this embodiment, the partition side surface 32 is perpendicular to the partition bottom surface 31. The partition side surface 32 further has an engaging groove 321 for the heat insulation ring 4 to be engaged with the partition side surface 32.

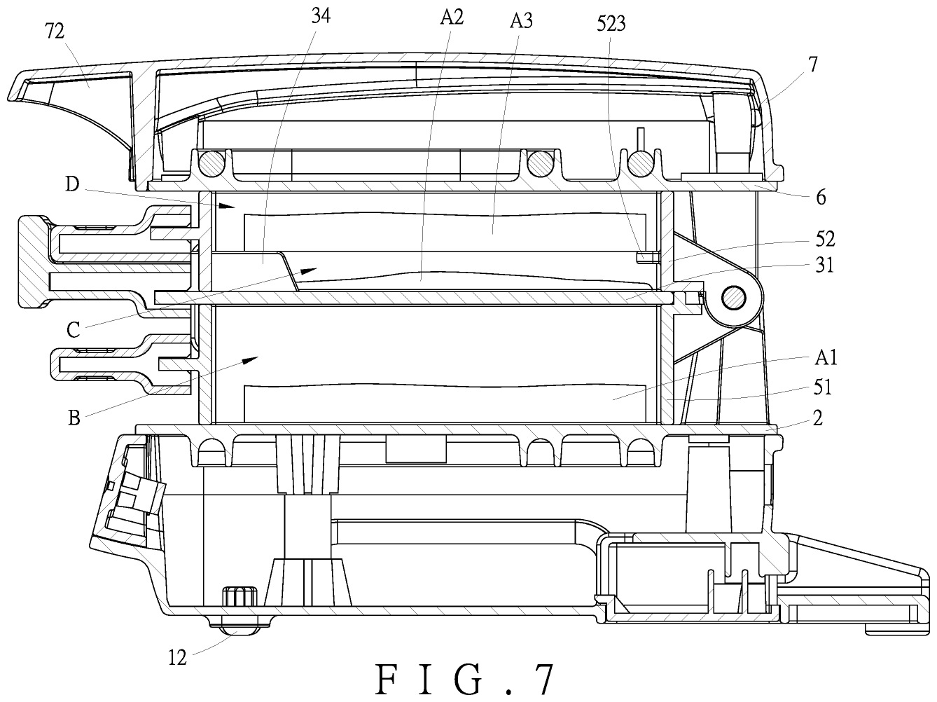

In addition to the handle 33 of the partition 3, the lower casing 1, the lower baking ring 51, the upper baking ring 52 and the upper casing 7 have a first grip 11, a second grip 511, a third grip 524 and a fourth grip 72 respectively, so as to prevent the user from being burned by the high-temperature sandwich maker after use. In this embodiment, the handle 33 just covers the third grip 524, which is convenient for the user to pivot the partition 3 and the upper baking ring 52 at the same time. The indicator light 9 is arranged on the first grip 11. The bottom of the lower casing 1 is provided with a pad 12, referring to FIG. 7, to prevent the sandwich maker from sliding. Preferably, the material of the heat insulation ring 4 is silicone.

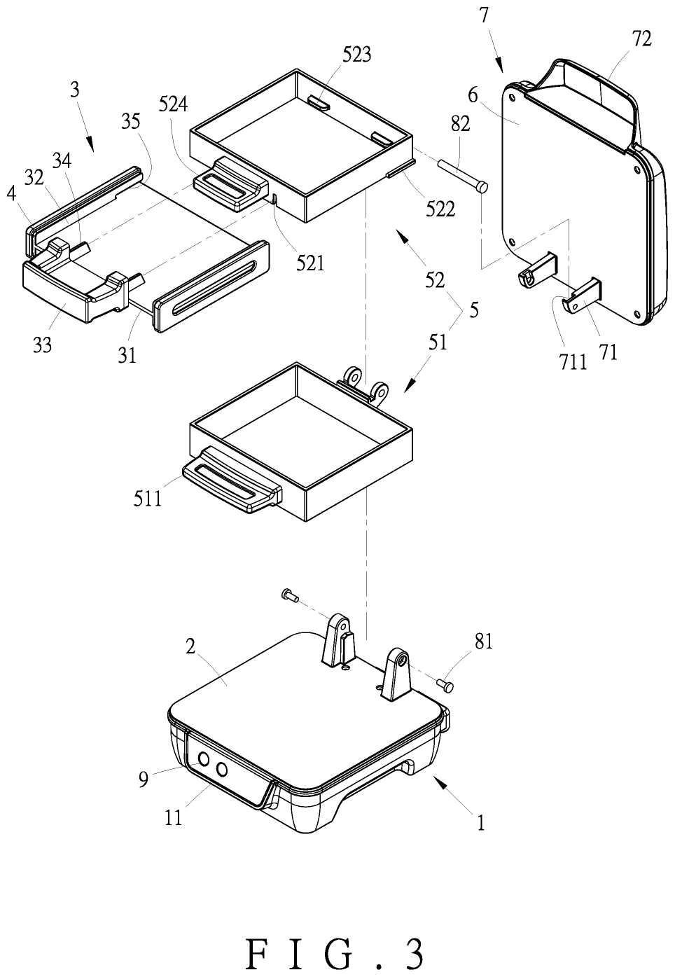

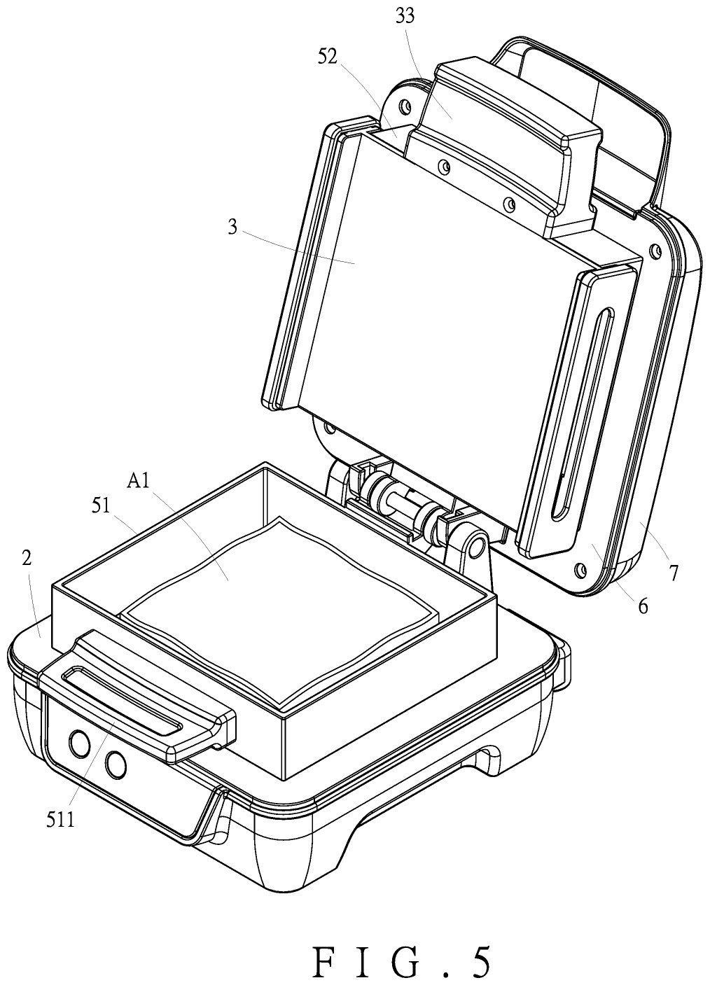

Referring to FIG. 3 and FIG. 5, when in use, the partition 3 is placed between the lower baking ring 51 and the upper baking ring 52, taking as an example. In actual implementation, the partition 3 may be removed in advance. First, the user holds the third grip 524 and the handle 33 to open the upper baking ring 52 together with the partition 3, the upper baking plate 6 and the upper casing 7, so that only the lower baking ring 51 is above the lower baking plate 2. Then, a first piece of toast A1 is placed in the center of the lower baking ring 51 to be in contact with the lower baking plate 2. Since the second coupling portion 35 of the partition 3 is correspondingly engaged with the first coupling portion 522 of the upper baking ring 52, the partition 3 can be driven by the upper baking ring 52 to pivot, and it is also convenient to remove the partition 3.

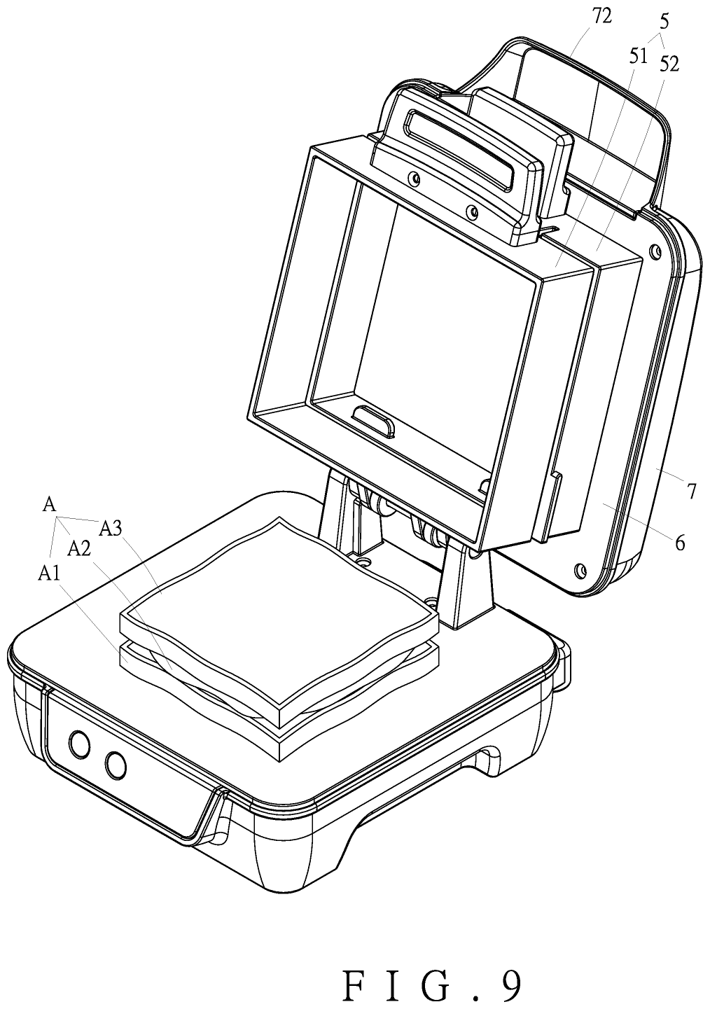

In this embodiment, the first piece of toast A1 serves as the bottom layer of a sandwich A. Please refer to the sandwich A as shown in FIG. 9. If an egg liquid or other liquid serves as the bottom layer of the sandwich A, the lower baking ring 51 can be used for shaping better. In the case of using the first piece of toast A1 or other food having a certain shape, in addition to holding the third grip 524 and the handle 33 as described above, the user can hold the second grip 511 to open the lower baking ring 51, the upper baking ring 52, the partition 3, the upper baking plate 6 and the upper casing 7, and then the first piece of toast A1 is directly placed on the center of the lower baking plate 2.

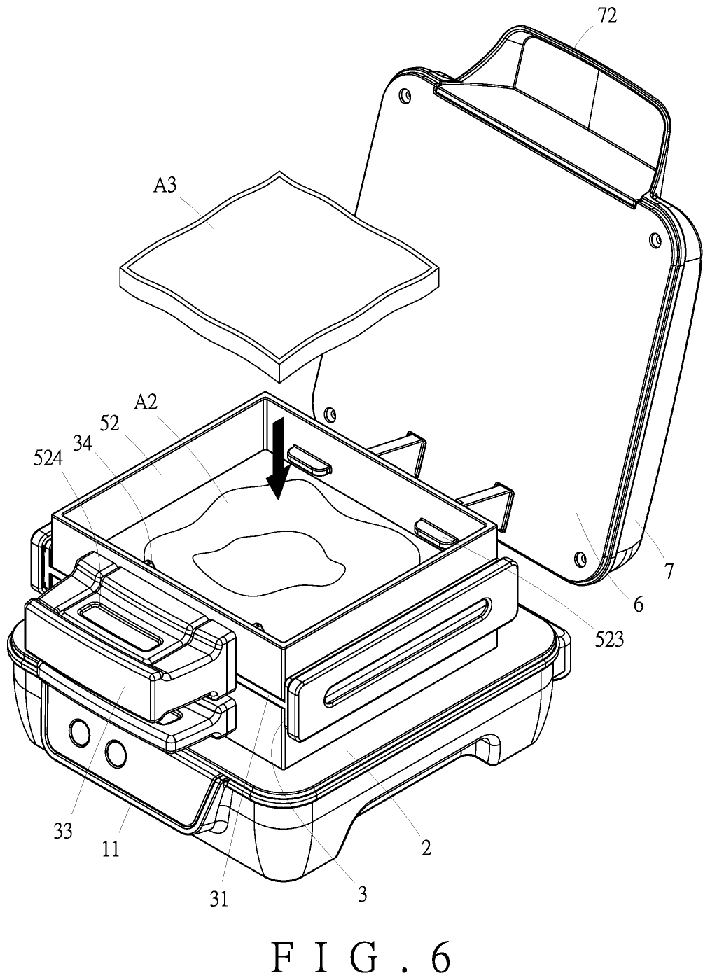

Referring FIG. 3, FIG. 5 and FIG. 6, after the first piece of toast A1 is placed on the lower baking plate 2, the user can hold the third grip 524 and the handle 33 to pivot the upper baking ring 52 together with the partition 3 to cover the lower baking plate 2. If the partition 3 has been removed at the beginning, the second rib 34 of the partition 3 needs to be inserted into the perforation 521 of the upper baking ring 52, and the partition bottom surface 31 is located between the lower baking ring 51 and the upper baking ring 52. Then, the next step is performed.

Then, the user can crack an egg A2 on the partition bottom surface 31 to serve as the middle layer of the sandwich A. Please refer to the sandwich A as shown in FIG. 9. A second piece of toast A3 is placed on the first rib 523 and the second rib 34 to be located in the upper baking ring 52, serving as the top layer of the sandwich A. The top layer of the sandwich A is preferably an ingredient having a certain shape. In actual implementation, the partition may be a plate. The plate can be inserted through the perforation 521 of the upper baking ring 52. At this time, an egg liquid or other liquid can serve as the top layer of the sandwich A.

Finally, the user can hold the fourth grip 72 and pivot the upper casing 7 together with the upper baking plate 6 to cover the lower baking plate 2. The sandwich maker is actuated to heat the upper baking plate 6 and the lower baking plate 2. If the ingredient as the top layer of the sandwich A is thick, the first grip 11 and the fourth grip 72 can be pressed at the same time to ensure that the upper baking plate 6 will not bounce off.

Referring to FIG. 7, at this time, the partition bottom surface 31, the lower baking ring 51 and the lower baking plate 2 define a first space B. The partition bottom surface 31, the upper baking ring 52, the first rib 523 and the second rib 34 define a second space C. The first rib 523, the second rib 34, the upper baking ring 52 and the upper baking plate 6 define a third space D. The first piece of toast A1 is located in the first space B, the egg A2 is located in the second space C, and the second piece of toast A3 is located in the third space D, so that the first piece of toast A1, the egg A2 and the second piece of toast A3 are not in contact with each other.

Because the first piece of toast A1, the egg A2 and the second piece of toast A3 are not in contact with each other, the first piece of toast A1 and the second piece of toast A3 won't be affected by the egg A2 to reduce the taste of the sandwich.

In the heating process of the upper baking plate 6 and the lower baking plate 2, the user can hold the fourth grip 72 to open the upper casing 7 together with the upper baking plate 6 to confirm the doneness of the egg A2 and whether the second piece of toast A3 is burnt or not.

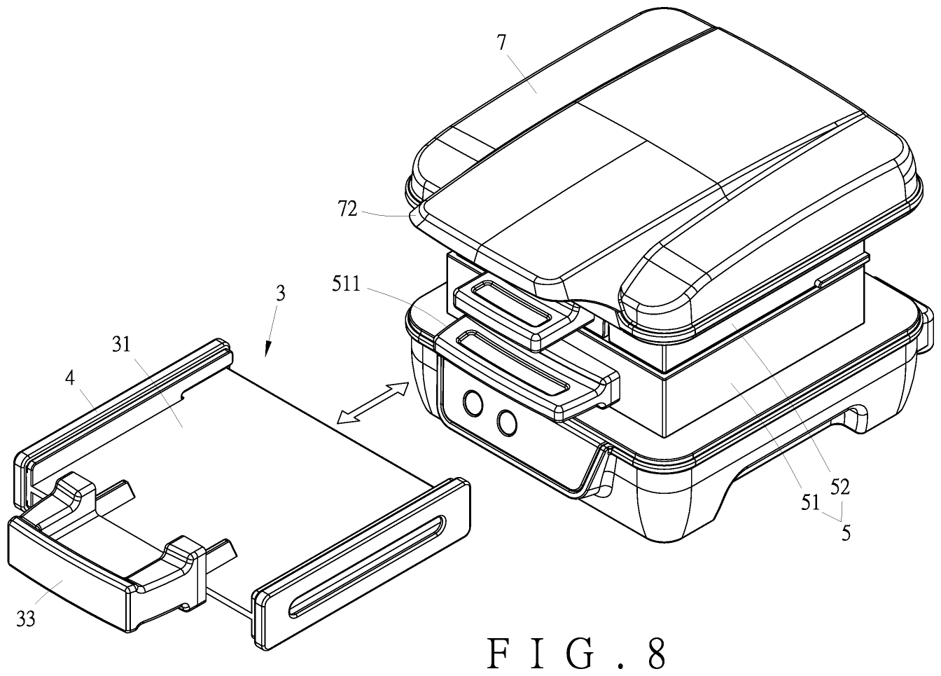

Referring to FIG. 7 through FIG. 9, when the egg A2 is cooked thoroughly, the partition 3 is pulled out through the handle 33 to separate the partition 3 together with the heat insulation ring 4 from the baking ring 5, so that the first space B, the second space C and the third space D communicate with each other. As shown in FIG. 8, only the upper casing 7 is closed as an illustration. In actual implementation, even if the upper casing 7 is opened, the partition 3 can be directly pulled out.

After the partition 3 is pulled out, the user can place the partition 3 on a tabletop through the heat insulation ring 4 without worrying that the high-temperature partition 3 may damage the tabletop.

At this time, the egg A2 and the second piece of toast A3 are not supported by the partition bottom surface 31, the first rib 523 and the second rib 34, they will fall onto the first piece of toast A1 to form a complete sandwich A. There is no need to use a food clamp for assembling the first piece of toast A1, the egg A2 and the second piece of toast A3 to form the sandwich A.

The user can hold the second grip 511 to open the lower baking ring 51, the upper baking ring 52, the upper baking plate 6 and the upper casing 7, and then the sandwich A can be taken out. In actual implementation, the user can hold the fourth grip 72 to open the upper baking plate 6 and the upper casing 7 only, and then the sandwich A can be taken out.

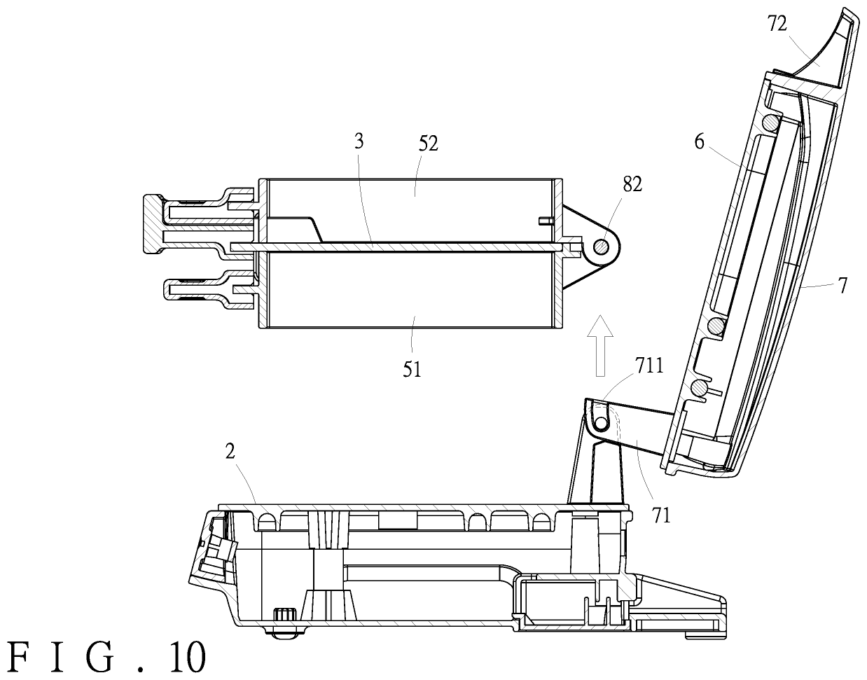

Referring to the FIG. 9 and FIG. 10, after the sandwich A is taken out, the user can hold the fourth grip 72 to open the upper casing 7 together with the upper baking plate 6. The lower baking ring 51 and the upper baking ring 52 are moved toward the notch 711, so that the second pivot rod 82 comes out of the pivot portion 71 from the notch 711. Then, the lower baking ring 51 and the upper baking ring 52 are separated from the upper baking plate 6 and the lower baking plate 2, and the lower baking ring 51 and the upper baking ring 52 can be removed for cleaning. FIG. 10 illustrates that when the partition 3 is between the lower baking ring 51 and the upper baking ring 52, the lower baking ring 51 and the upper baking ring 52 together with the partition 3 can be removed directly.

After the lower baking ring 51 and the upper baking ring 52 are cleaned, the second pivot rod 82 is aligned with the notch 711 for the lower baking ring 51 and the upper baking ring 52 to be pivotally connected to the pivot portion 71.

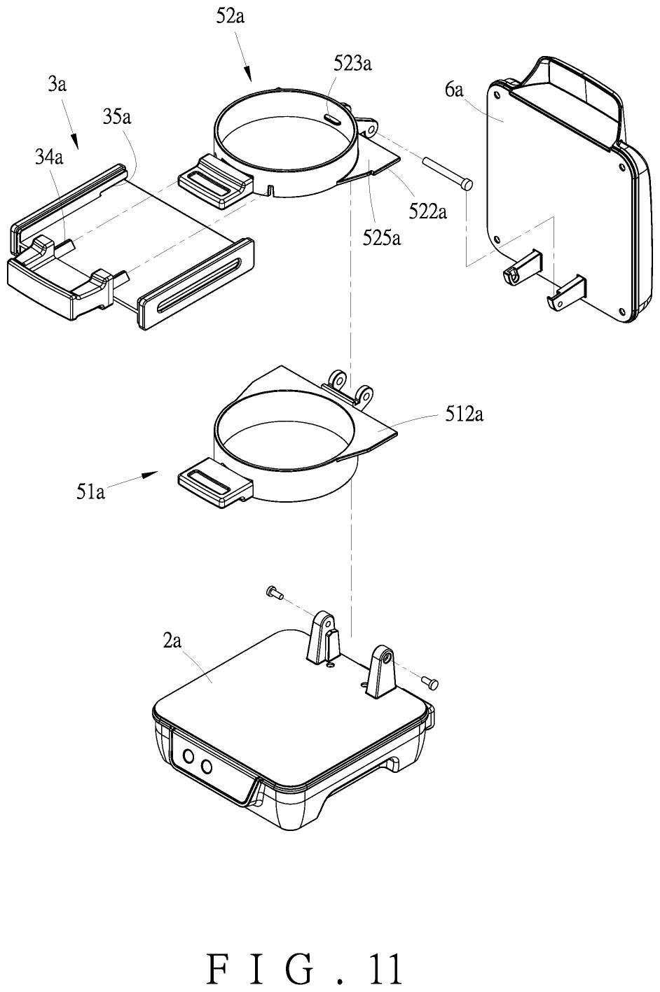

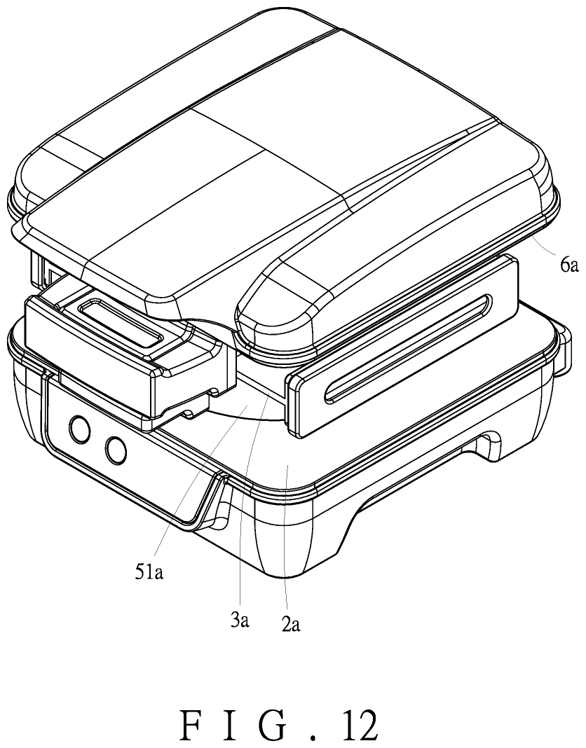

FIGS. 11-13 disclose a second embodiment of the sandwich maker of the present invention. The second embodiment is substantially similar to the first embodiment with the exceptions described hereinafter. In the first embodiment, referring to FIG. 9, the lower baking ring 51 and the upper baking ring 52 each have a square shape, so that the first embodiment is more suitable for the first piece of toast A1 and the second piece toast A2 with a square shape. In the second embodiment, the lower baking ring 51 and the upper baking ring 52 each have a circular shape, so that the second embodiment is more suitable for round food materials, such as, the first piece of toast A1 and the second piece toast A2 that are cut into a circle in advance, English muffins, etc. In this embodiment, a first hamburger bun E1, an egg E2 and a second hamburger bun E3 are assembled to form the sandwich E, and the egg E2 is also shaped into a circle by the upper baking ring 52.

The lower baking ring 51a and the upper baking ring 52a each have a wing 512a, 525a. The wing 525a of the upper baking ring 52a is provided with the first coupling portion 522a to be correspondingly engaged with the second coupling portion 35a of the partition plate 3a.

The sandwich maker of this embodiment also uses the partition 3a, the first rib 523a and the second rib 34a to separate the first hamburger bun E1, the egg E2 and the second hamburger bun E3 for cooking. After the partition 3a is pulled out of the lower baking ring 51a and the upper baking ring 52a, the first hamburger bun E1, the egg E2 and the second hamburger bun E3 directly form the complete sandwich E. The other structures and cooking steps of this embodiment are the same as those of the first embodiment, and will not be repeated hereinafter.

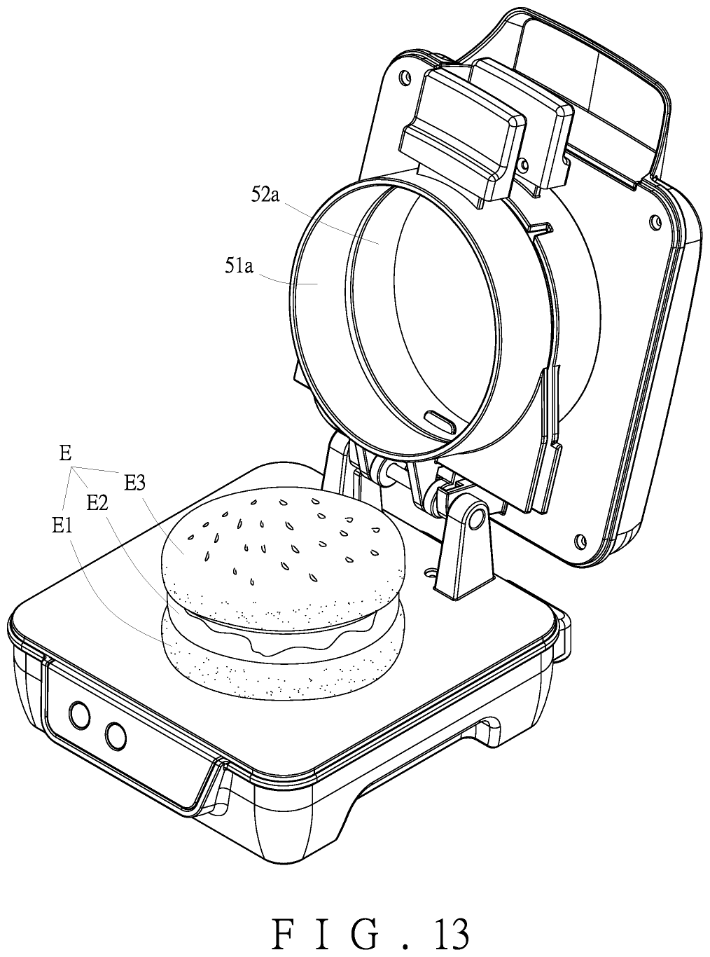

Referring to FIG. 9 and FIG. 13, the different shapes of the lower baking ring 51, 51a and the upper baking ring 52, 52a can be applied to different ingredients of the sandwich A, E and improve the convenience of use of the sandwich maker.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A sandwich maker, comprising:
a lower baking plate;
a baking ring, adjacent to the lower baking plate, the baking ring being pivotable relative to the lower baking plate;
an upper baking plate, adjacent to the baking ring, the upper baking plate being pivotable relative to the lower baking plate;
a partition, selectively coupled to the baking ring, the partition having a partition bottom surface, a partition side surface, a handle and a partition element, wherein when the partition is coupled to the baking ring, the partition bottom surface is located between the lower baking plate and the upper baking plate, the partition side surface and the handle extend out of the baking ring, and the partition element is arranged at a distance from the partition bottom surface;
a heat insulation ring, coupled to the partition side surface;
the partition bottom surface, the baking ring and the lower baking plate defining a first space, the partition bottom surface, the baking ring and the partition element defining a second space, the partition element, the baking ring and the upper baking plate defining a third space;
wherein when the partition is pulled through the handle to separate the partition together with the heat insulation ring from the baking ring, the first space, the second space and the third space communicate with each other.

2. The sandwich maker as claimed in claim 1, wherein the baking ring includes a lower baking ring and an upper baking ring that are pivotable relative to the lower baking plate, the lower baking ring is adjacent to the lower baking plate, the upper baking ring is adjacent to the lower baking ring and the upper baking plate, the partition is selectively coupled between the lower baking ring and the upper baking ring, when the partition is coupled between the lower baking ring and the upper baking ring, the partition bottom surface is located between the lower baking ring and the upper baking ring, the handle extends out of the lower baking ring and the upper baking ring, the partition element extends from the handle into the upper baking ring; the partition bottom surface, the lower baking ring and the lower baking plate define the first space; the partition bottom surface, the upper baking ring and the partition element define the second space; the partition element, the upper baking ring and the upper baking plate define the third space.

3. The sandwich maker as claimed in claim 2, further comprising an upper casing and a lower casing that are pivotally connected to each other through a pivot rod, the upper baking plate and the lower baking plate being coupled to opposing surfaces of the upper casing and the lower casing respectively, the lower baking ring and the upper baking ring being pivotally connected to the pivot rod.

4. The sandwich maker as claimed in claim 3, wherein the pivot rod includes a first pivot rod and a second pivot rod, the upper casing has a pivot portion, the pivot portion of the upper casing and the lower casing are pivotally connected to each other through the first pivot rod, the pivot portion of the upper casing, the lower baking ring and the upper baking ring are all pivotally connected to the second pivot rod, the pivot portion has a notch, the notch has a width not less than a diameter of the second pivot rod; when the lower baking ring and the upper baking ring are moved toward the notch, the second pivot rod comes out of the pivot portion from the notch for the lower baking ring and the upper baking ring to be separated from the upper baking plate and the lower baking plate.

5. The sandwich maker as claimed in claim 3, wherein a bottom of the lower casing is provided with a pad.

6. The sandwich maker as claimed in claim 2, wherein the upper baking ring has a perforation and a first rib, the partition element is a second rib, when the partition is coupled between the lower baking ring and the upper baking ring, the second rib passes through the perforation and extends into the upper baking ring, and the second rib corresponds to the first rib.

7. The sandwich maker as claimed in claim 2, wherein an outer edge of the upper baking ring is provided with a first coupling portion, an inner edge of the partition is provided with a second coupling portion, when the partition is coupled between the lower baking ring and the upper baking ring, the first coupling portion is engaged with the second coupling portion.

8. The sandwich maker as claimed in claim 2, wherein the partition side surface is perpendicular to the partition bottom surface, and the partition side surface further has an engaging groove for the heat insulation ring to be engaged with the partition side surface.

9. The sandwich maker as claimed in claim 2, wherein a grip protrudes from one or a combination of the lower baking plate, the lower baking ring, the upper baking ring and the upper baking plate.

10. The sandwich maker as claimed in claim 1, wherein an indicator light is electrically connected to the upper baking plate and/or the lower baking plate.
